(19) United States
(12) Patent Application Publication
(10) Pub. No.: US 2019/0140375 A1
(43) Pub. Date: May 9, 2019

(54) PLUG CONTACT

(71) Applicant: PHOENIX CONTACT GMBH & CO. KG, Blomberg (DE)

(72) Inventors: Arndt SCHAFMEISTER, Dörentrup (DE); Ralf GESKE, Schieder-Schwalenberg (DE)

(73) Assignee: Phoenix Contact GmbH & Co. KG, Blomberg (DE)

(21) Appl. No.: 16/095,440

(22) PCT Filed: Apr. 21, 2017
(86) PCT No.: PCT/EP2017/059545

§ 371 Date: Oct. 22, 2018

(30) Foreign Application Priority Data
Apr. 22, 2016 (LU) 93039

(51) Int. Cl. H01R 12/58; H01R 12/75; H01R 13/05; H01R 4/48

(52) U.S. Cl. CPC H01R 12/585; H01R 4/4836; H01R 13/05; H01R 12/75

(57) ABSTRACT

A plug contact for electrically contacting a circuit board by insertion of the plug contact into a contact hole of the circuit board, the plug contact having two contact legs, which are resilient relative to each other, a connection region, and a connecting region. The connecting region connects the two contact legs to one another and to the connection region. The plug contact is stamped from a flat metal material and is bent. The plug contact enables secure contacting, even in the case of a small material thickness of the flat material, in that the two contact legs each have a first section and a second section adjoining the first section in the insertion direction of the plug contact, and by the two contact legs being bent from the plane of the connecting region.

### BACKGROUND OF THE INVENTION

### Field of the Invention

The invention relates to a plug contact for making electrical contact with a circuit board by plugging the plug contact into a contact hole of the circuit board, with two contact legs which are resilient relative to one another, a terminal region and a connecting region, the connecting region connecting the two contact legs to one another and to the terminal region, and the plug contact being made from a metallic flat material.

In addition, the invention relates to an electrical supply terminal with a housing, with a conductor terminal element and with a conductor bar piece, a conductor which is to be connected being connectable in an electrically conductive manner to the conductor bar piece by means of the conductor terminal element and in the housing a conductor entry opening being made for entry of an electrical conductor which is to be connected.

### Description of Related Art

Plug contacts for producing electrical connections between conductors, different electrical or electronic components and conductor bars are known in various embodiments and for various applications. For this purpose the plug contacts are plugged into corresponding receiving contacts or socket elements, and the receiving contacts can be for example openings in conductor bars. The plug contacts themselves can be connected to electrical components and can be designed for connection to electrical conductors, for which then the terminal region of the plug contacts is made accordingly.

For the connection between a circuit board and an electrical component or the connection of a conductor to a circuit board, there are various techniques, in practice mainly soldering and press-fitting having become established. Both techniques have proven themselves over the years since they ensure a good and permanent electrical contact between the contact partners. One disadvantage both of soldering and press-fitting is that the two connecting techniques are not reversible, so that a connection, once established, cannot be broken again at all or can be only with increased effort. Moreover, to produce the connection additional working steps and/or special tools are necessary. Here plug-and-socket connections which have been used for decades in other applications offer one alternative, since the connection can be easily established by hand, and moreover, can also be broken again if necessary, and is therefore reversible.

Electrical supply terminals have also been known for decades in a host of versions. The supply terminals can be made, for example, for connecting one electrical conductor or several conductors to a circuit board as a so-called printed board terminal, for which the supply terminals can have corresponding contact pins which can be soldered or press-fitted into the corresponding holes in the circuit board. The conductor terminal element can be for example a screw terminal by which a conductor which is to be connected can be joined in an electrically conductor manner to the conductor bar piece. Likewise, the conductor terminal element can also be made as a crimp connection to which the stripped end of a conductor to be connected can be attached, the crimp connection then being made on one end of the conductor bar piece and the contact pin being made on the other end of the conductor bar piece. An insulation piercing terminal in which one insulated end of a conductor is forced into the cutting edges of the insulation piercing terminal is also possible as a conductor terminal element.

Conductor terminal elements can moreover also be clamping springs, both loop-shaped clamping springs, so-called tension spring clamps, and also U-shaped or V-shaped clamping springs being used. Rigid conductors or conductors provided with a wire end ferrule can be plugged directly, i.e., without the clamping site having to be opened beforehand with a tool, into U-shaped or V-shaped clamping springs. In the known U-shaped or V-shaped clamping springs the conductor which is to be connected is forced by the clamping leg of the clamping spring against the conductor bar piece, as a result of which the electrical connection between the conductor and the conductor bar piece is established. To connect flexible conductors the clamping site between the clamping leg and the conductor bar piece must be opened, for which in the housing an actuating opening is made for insertion of a tool, for example the tip of a screwdriver. The actuating opening is also used to open the clamping site in order to be able to pull a connected conductor out of the clamp again.

For some time, a plug contact which has been made for use in circuit boards has been known from practice; it is made in the manner of a spring fork and has two flat contact legs which are resilient relative to one another and which are joined to one another via a common connecting region. The plug contact is punched out of a flat metallic material and bent, to produce the two contact legs a region as narrow as possible being punched out between the contact legs. In the plugged-in state, the contact legs with their outer punching edges press against the inside wall of the contact hole into which the plug contact has been plugged. The terminal region which is opposite the contact legs is made as a crimp connection so that one conductor at a time can be connected to a respective plug contact.

So that the two contact legs can be reliably produced using punching technology, their width must correspond roughly to their thickness, the material thickness of the flat material out of which the plug contact has been punched. Since the width of the region which has been punched out between the two contact legs corresponds roughly to the material thickness of the flat material, the result is that the width of the individual contact legs is only barely ⅓ of the total width of the plug contact. The total width of the plug contact, i.e., the width of the two contact legs and the width of the region which has been punched out between the two contact legs, is determined by the diameters of the contact hole in the circuit board into which the plug contact is to be plugged. For small hole diameters this leads to the contact legs of the plug contact having to be made very narrow and thin. First of all, this can be difficult to accomplish using punching technology, and moreover, leads to the normal contact force which can be applied by the contact legs being only relatively small.

While in the press-fit connection a gas-tight connection between the contact partners arises due to the high forces during the connection process, in a plug-and-socket connection such an intermetallic connection does not occur. In a plug-and socket connection, the contact partners, i.e., the plug contact and the contact hole in the circuit board, press against one another with the normal contact force. The latter must be large enough to be able to ensure good and permanent electric contact between the contact partners. If the contact legs are too narrow or too thin, the normal contact force may not be great enough to permanently ensure good electrical contact.

A supply terminal with several of the above described plug contacts is known from

German Patent Application DE 10 2011 011 017 A1. The individual plug contacts are arranged in several rows next to one another in chambers of the terminal housing such that the plug contacts extend perpendicular to the plane of the circuit board. To connect individual conductors, the terminal regions are made as a crimp connection in the individual plug contacts. In this way several conductors can be connected to one circuit board in which the individual contact holes have a short distance to one another. Subsequent connection or detachment of individual conductors is however not possible in the known supply terminal.

A fork-shaped plug contact for making contact with a circuit board is also known from German Utility Model DE 202 18 295 U1. In this plug contact, the contact legs with their outer punching edges also press against the inside wall of the contact hole, the two contact legs each having two outside edges which when the plug contact is being forced into the contact hole of the circuit board are buried in the metal coating of the wall of the hole. Preferably, cold welds between the metal coating of the wall of the hole and the contact legs will occur in order to ensure good electrical contact. Subsequently breaking the connection, however, is not possible at all or is so only with difficulty.

### SUMMARY OF THE INVENTION

The object of this invention is to make available the initially described plug contact which even at small material thickness of the flat material enables reliable contact-making with the contact hole so that the plug-in connector ensures good and permanent electrical contact between the contact partners. Moreover, if necessary the plug contact can also be pulled out of the contact hole again. Moreover an electrical supply terminal can be devised with which an electrical conductor can be easily connected to a circuit board.

This object is achieved in a plug contact of the initially described type by the two contact legs each having a first section and a second section which adjoins it in the plug-in direction of the plug contact. The two contact legs are bent out of the plane of the connecting region such that the connecting region and the first regions of the two contact legs which border the connecting region together form a U-shaped outline. The contact-making regions which make contact with the contact hole in the plugged-in state of the plug contact are made on the outer sides of the second sections of the two contact legs, which sides face away from one another, one contact leg at a time having one contact-making region.

In contrast to the plug contacts which are known from the prior art, the contact legs and the connecting region thus do not extend in a common plane, but the contact legs are bent opposite the connecting region. This leads to the contact legs in the plugged-in state pressing, not with their punching edges, but with their outer sides of the second sections, which sides face away from one another, against the inside wall of the contact hole. This results in that the contact-making region of the contact legs is no longer dependent directly on the material thickness of the flat metallic material from which the plug contact is produced. With respect to the configuration of the contact legs, in particular their geometry and the shape of the contact-making regions, there are thus more shaping clearances so that the plug contact and in particular the contact legs can be better adapted to the respective dimensions of the contact hole.

Because, in the plug contact in accordance with the invention, the contact-making regions of the contact legs are made, not on their punching edges, but on the rolled side of the flat metallic material, the contact-making regions can be easily provided with a coating, for example, they can be gold-plated. Since the contact-making regions are not made on the punching edges, the coating can already be applied to the flat metallic material from which the plug contacts are produced, they can be punched out and bent. Subsequent complex coating of the individual plug contacts which have already been punched out and optionally bent can be eliminated in this way.

According to one advantageous configuration of the plug contact in accordance with the invention, the second sections of the two contact legs at least in their contact-making region each have an outside contour which is rounded in cross section. The edges of the contact legs are thus worked in particular in the region in which the contact legs in the plugged-in state make contact with the contact hole such that they do not have sharp edges which when the plug contact is plugged into the contact hole are buried in the metal coating of the wall of the hole. For this purpose, the outside contour of the contact legs can have a radius which is smaller than the radius of the contact hole. This makes it possible to plug in and unplug the plug contact several times without major damage occurring on the inside wall of the contact hole in the circuit board. Preferably, the contact-making regions of the two contact legs are crowned. The crowned shape of the contact-making regions can be easily produced by means of a die into which the corresponding regions of the second sections of the contact legs are forced before the contact legs are bent out of the plane of the connecting region.

It has already been stated above that because the contact legs are bent out of the plane of the connecting region and the contact-making regions are not located on the punching edges of the contact legs, the geometry of the contact legs can be more easily adapted to the respective requirements, in particular to the dimensions of the contact hole. The two contact legs are located preferably mirror-symmetrically to one another here, their having a distance from one another over their entire longitudinal extension. Preferably the contact legs are bent such that the distance of the two contact legs to one another is least in the region of their free ends. The distance of the contact legs from one another is preferably greatest in the region of their first sections so that the connecting region can have a width which ensures relative stability of the plug contact even in plug contacts which are designed for plugging into contact holes with small diameters.

According to another advantageous configuration of the plug contact in accordance with the invention, the two contact legs in their contact-making region moreover have a smaller width than in their first section. This also makes it possible to make available a plug contact which can be plugged into contact holes with a small diameter without the width of the contact legs having to be chosen to be correspondingly small overall. This facilitates the production of the plug contact since the contact legs in the section in which they are bent away from the connecting region need not be too narrow. Moreover, the normal contact force which can be applied by the contact legs does not become too small so that even at small material thickness permanent good electrical contact can be ensured.

The initially named object is achieved in the electrical supply terminal that has a plug contact in accordance with the invention which is located at least partially in the housing of the supply terminal such that the conductor bar piece is formed by the terminal region or a section of the terminal region of the plug contact, the contact legs of the plug contact with their second sections or their contact-making regions protruding out of the bottom of the housing. The bottom of the housing is considered the side which is facing the circuit board when the supply terminal is being mounted on the circuit board. With respect to the advantages of the electrical supply terminal in accordance with the invention, reference is made to the aforementioned in conjunction with the plug contact in accordance with the invention.

To connect the conductor to the supply terminal, different connecting techniques can be used, i.e., the plug contact us claimed in accordance with the invention can be used in supply terminals with different connecting techniques. The conductor terminal element can be for example a screw clamp or an insulation piercing clamp by which a conductor to be connected can be connected in an electrically conductive manner to the conductor bar piece. Likewise, the conductor terminal element can also be made as a crimp connection to which the stripped end of a conductor to be connected can be attached.

According to one preferred configuration, the conductor terminal element is a clamping spring which has one clamping leg and one contact leg, the clamping leg together with the corresponding sections of the terminal region of the plug contact forming a spring force clamping terminal for the conductor which is to be connected. The use of a clamping spring as a conductor terminal element has the additional advantage that a conductor to be connected via the spring force clamping terminal can be very easily connected to the supply terminal and thus also to the circuit board. If necessary, the electrical conductor can also be pulled out of the supply terminal again when the spring force clamping terminal is being opened. The electrical connection between the conductor and the circuit board can thus be broken both between the conductor and the terminal region of the plug contact and also between the contact legs of the plug contact and the circuit board.

If the terminal region extends in the longitudinal direction of the contact legs in the electrical supply terminal, the conductor inlet opening is located on the top of the housing and an electrical conductor to be connected is plugged into the supply terminal perpendicular to the plane of the circuit board. But in addition, it is also possible for the terminal region of the plug contact to be bent perpendicular or at an angle not equal to 90° to the longitudinal direction of the contact legs so that then the conductor inlet opening is arranged accordingly on one front end of the housing. In both cases, the electrical conductor is forced away from the free end of the contact leg against the corresponding section of the terminal region, as a result of which the electrical connection is established between the conductor and the plug contact. The conductor can be easily detached from the supply terminal by the clamping site being opened for which the clamping leg of the clamping spring is deflected by means of a tool inserted into the actuating opening or an actuating pusher located in the actuating opening against its spring force. The conductor can then be extracted again from the clamping site between the clamping leg and the terminal region of the plug contact.

In order to achieve good electrical contact between a plugged-in electrical conductor and the plug contact, preferably several grooves or notches are made on the side of the terminal region of the plug contact facing the clamping leg. This structure of the terminal region increases the unit pressure between the plugged-in conductor and the plug contact; this leads to lower contact resistance.

For simple installation of the electrical supply terminal on a circuit board, it is provided according to another advantageous configuration that on the bottom of the housing several adjusting elements are made which when the supply terminal is being mounted on the circuit board are inserted into corresponding recesses in the circuit board. The ends of the adjusting elements are made preferably conical; this facilitates the insertion of the adjusting elements into the corresponding recesses in the circuit board. Moreover, the length of the adjusting elements is chosen in such a way that when the supply terminal is being mounted on the circuit board first the adjusting elements with their free ends engage the corresponding recesses in the circuit board before the contact-making regions of the contact legs of the plug contact dip into the corresponding contact holes in the circuit board.

According to another advantageous configuration of the electrical supply terminal in accordance with the invention, in addition to the adjusting elements at least two locating elements are made on the bottom of the housing and engage corresponding recesses in the circuit board. Corresponding locating projections or locating lugs can ensure that the electrical supply terminal after mounting on a circuit board is reliably fastened to the latter. Preferably the locating elements are made such that they can be shifted out of a first unlatched state into a second latching state and vice versa. In this way it is possible to release the latching between the housing of the electrical supply terminal and the circuit board again so that the electrical supply terminal can be lifted again off the circuit board.

In particular, there is at this point a host of possibilities for configuring and developing the plug contact in accordance with the invention and the electrical supply terminal in accordance with the invention. For this purpose reference is made to the following description in conjunction with the accompanying drawings.

### BRIEF DESCRIPTION OF THE DRAWINGS

FIG. 1 shows a perspective of one preferred exemplary embodiment of a plug contact in accordance with the invention, with a clamping spring,

FIG. 2 shows the plug contact according to FIG. 1, from the back,

FIG. 3 shows an enlarged perspective of a plug contact in accordance with the invention, with another terminal region,

FIGS. 4a & 4b show two fabrication stages in the production of the plug contact according to FIG. 1,

FIG. 5 shows one preferred exemplary embodiment of an electrical supply terminal in accordance with the invention, plugged onto a circuit board,

FIG. 6 shows the electrical supply terminal according to FIG. 5, in cross section, and

FIG. 7 shows an enlarged extract of the electrical supply terminal according to FIG. 6.

### DETAILED DESCRIPTION OF THE INVENTION

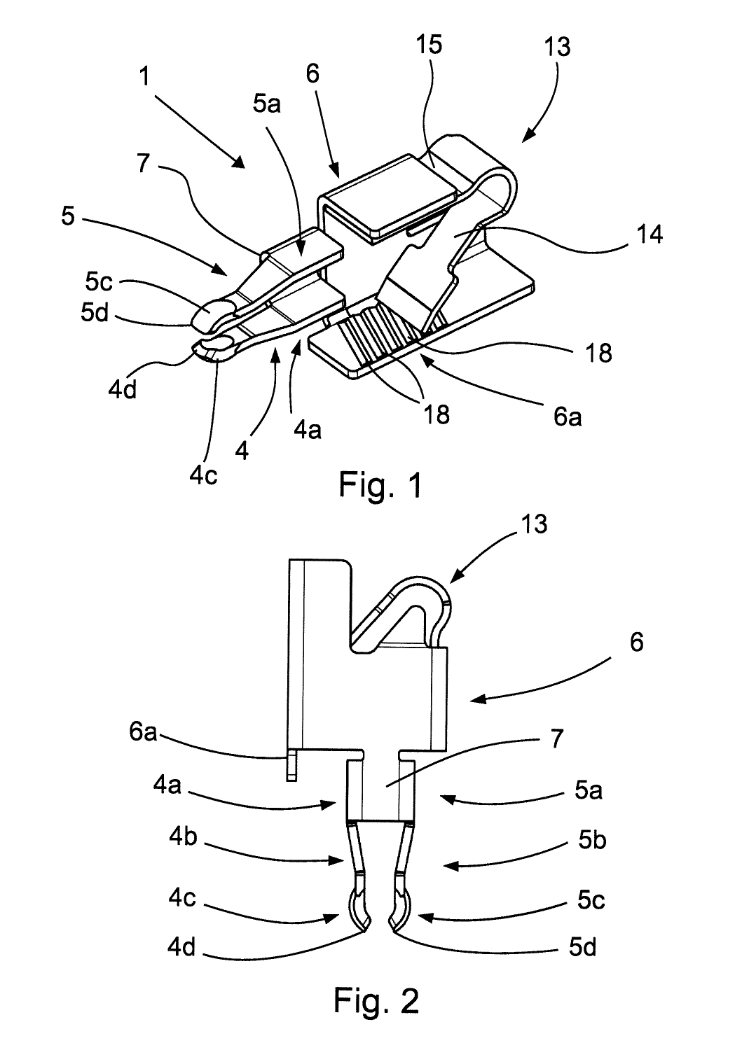

FIGS. 1 and 2 show one preferred exemplary embodiment of a plug contact 1 for making contact with a circuit board 2, for which the plug contact 1 is plugged into a corresponding contact hole 3 in the circuit board 2 (compare FIGS. 6 and 7). The plug contact 1 which is punched out of a flat metallic material and bent has two contact legs 4, 5 which are resilient relative to one another, one terminal region 6 and one connecting region 7, the two contact legs 4, 5 being connected to one another and to the terminal region 6 via the connecting region 7.

The two contact legs 4, 5 each have a first section 4a, 5a and a second section 4b, 5b which adjoins the first section 4a, 5a in the plug-in direction E of the plug contact 1. As is especially apparent from FIG. 1, the two contact legs 4, 5 are bent out of the plane of the connecting region 7 so that the connecting region 7 and the first regions 4a, 5a of the two contact legs 4, 5 adjoining it together form a U-shaped outline. The contact legs 4, 5 are bent roughly perpendicular away from the connecting region 7 so that the connecting region 7 forms the U-back bridging between the two first sections 4a, 5a of the contact legs 4, 5 which form the legs of the U-shaped outline.

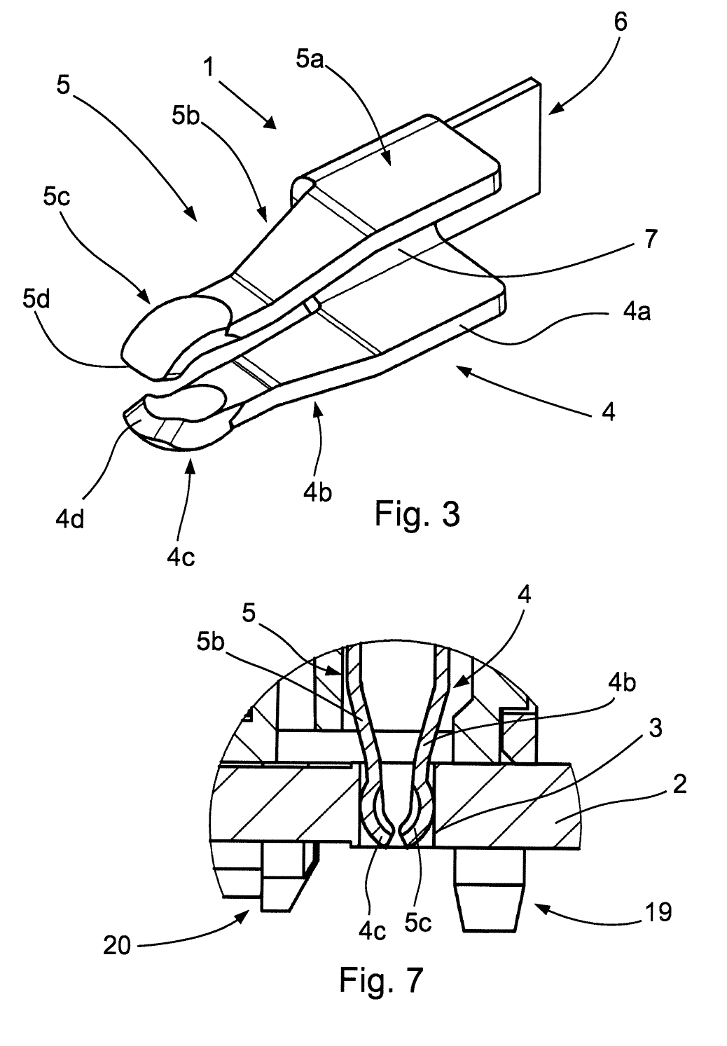

On the outer sides of the two sections 4b, 5b of the two contact legs 4, 5, which sides face away from one another, the contact-making regions 4c, 5c are made which, in the plugged-in state of the plug contact make contact with the contact hole 3. As is apparent from FIGS. 1 and 2 and in particular also from the enlarged view according to FIG. 3, the contact-making regions 4c, 5c are crowned. The radius of the outside contour of the contact-making regions 4c, 5c is thus somewhat smaller than the radius of the contact hole 3 so that when the contact legs 4, 5 are plugged into the contact hole 3 the metal-coated inside wall of the contact hole 3 is not damaged.

As is apparent from FIGS. 1 to 3, the two contact legs 4, 5 are located mirror-symmetrically to one another and have a distance from one another over their entire longitudinal extension. The distance of the contact legs 4, 5 from one another is least in the region of their free ends 4d, 5d, while it is greatest in the region of the first sections 4a, 5a. The contact legs 4, 5 are thus bent towards one another proceeding from the connecting region 7 or from their first sections 4a, 5a, moreover the width of the contact legs 4, 5 also diminishing in the direction of the free ends 4d, 5d. In this way the contact legs 4, 5 can be plugged into a contact hole 3 whose diameter is smaller than the distance of the two first sections 4a, 5a of the two contact legs 4, 5 or the width of the connecting region 7. Thus a plug contact 1 can be made which can be plugged into very small contact holes 3 and still has sufficiently great stiffness and stability so that when the contact legs 4, 5 are plugged into the contact hole 3 the plug contact 1 is not deformed.

The plug contact 1 which is shown enlarged in FIG. 3 differs from the plug contact 1 which is shown in FIGS. 1 and 2 only by a somewhat different configuration of the terminal region 6. The terminal region 6 is made here as a straight tongue which is used in the same manner as the section 6a of the terminal region 6 according to FIGS. 1 and 2 for making contact with an electrical conductor.

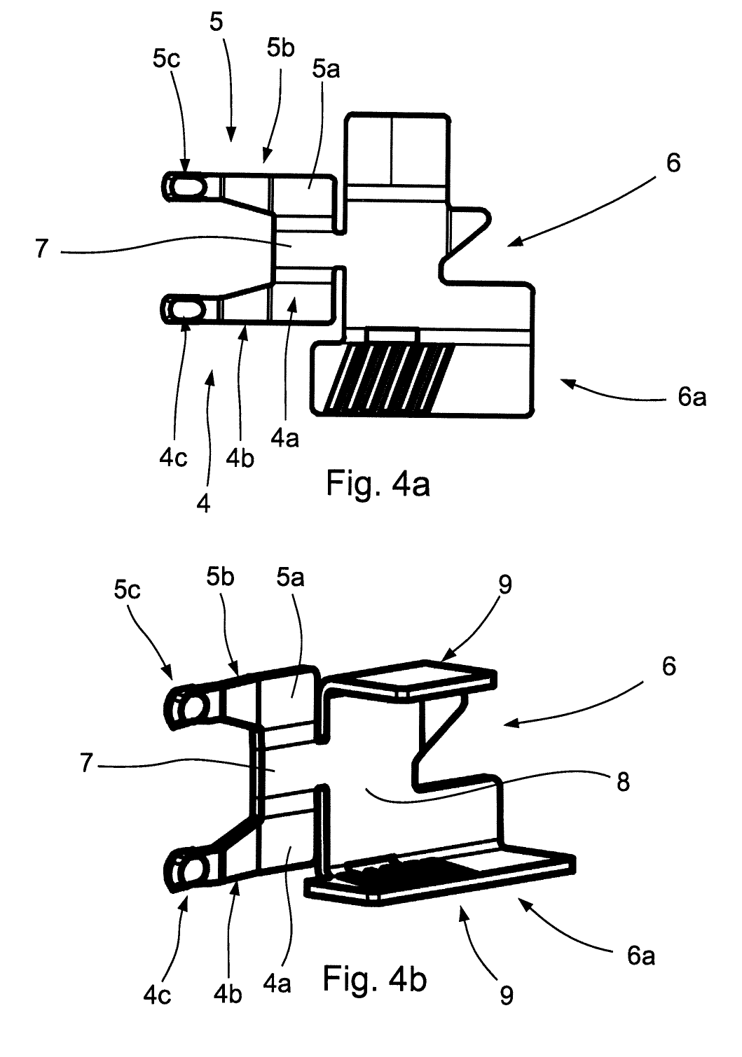

FIG. 4 shows two intermediate steps in the production of the plug contact 1 in accordance with the invention, FIG. 4a showing the plug contact 1 after punching out from a flat metallic material. The flat metallic material can have a thickness of less than 0.5 mm, for example a thickness of only 0.3-0.4 mm. The crowned shape of the contact-making regions 4c, 5c has been produced by the corresponding regions of the second sections 4b, 5b of the contact legs 4, 5 having been forced into a die. In FIG. 4b, after one further method step two sections of the terminal region 6 are bent upward so that the terminal region 6 has a U-shaped outline with one U-back 8 and two side walls 9. Finally, the two contact legs 4, 5 are bent out of the plane of the connecting region 7 essentially perpendicularly up and the second sections 4b, 5b of the contact legs 4, 5 are bent towards one another so that the shape of the plug contact 1 which is shown in FIG. 1 is achieved.

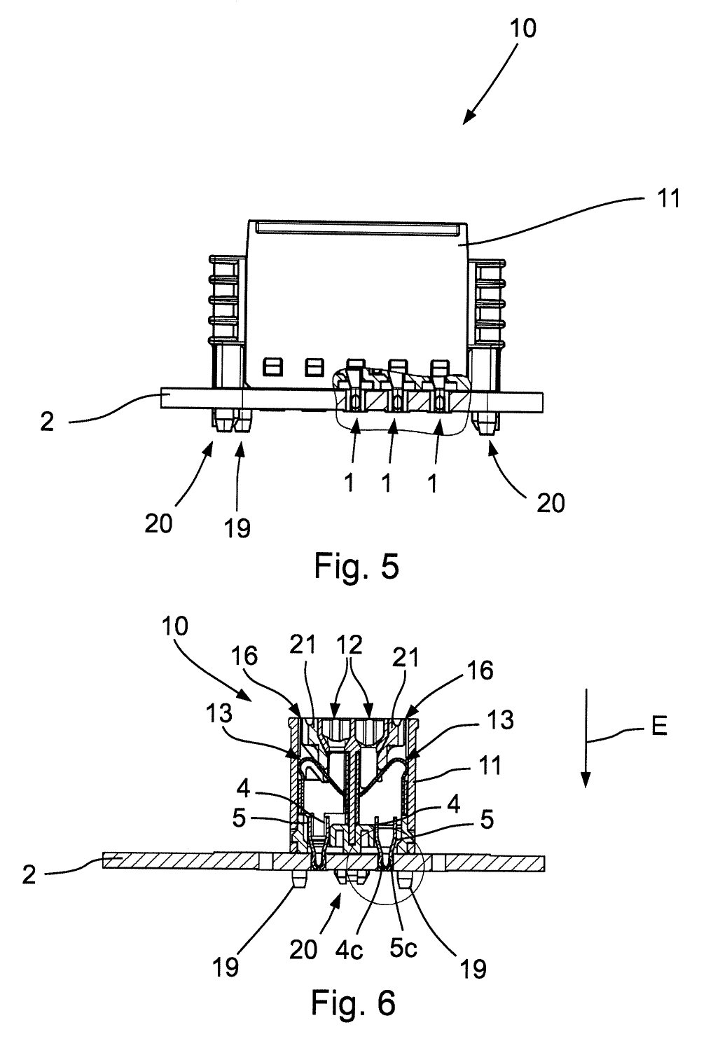

FIGS. 5 and 6 show one preferred exemplary embodiment of an electrical supply terminal 10 in accordance with the invention which has a housing 11 which generally consists of plastic. In the housing 11 there are several conductor inlet openings 12 and a corresponding number of clamping springs 13 and plug contacts 1. The exemplary embodiment of the electrical supply terminal 10 which is shown in the figures is used to connect ten individual conductors so that in the housing 11 there are also a total of ten clamping springs 13 and ten plug contacts 1, two clamping springs 13 at a time being located mirror-symmetrically opposite one another, as is apparent from FIG. 6. The individual clamping springs 13, of which, in the cross section according to FIG. 6, two in the supply terminal 10 opposite one another are recognizable, each have a clamping leg 14 and a contact leg 15.

Each clamping spring 13 is assigned a plug contact 1 such that a section 6a of the terminal region 6 of one plug contact 1, which section is formed by a side wall 9, together with the free end of the clamping leg 14 of a clamping spring 13, forms a spring force clamping terminal for an electrical conductor which has been inserted into the housing 11 through a conductor inlet opening 12. Since the supply terminal 10 is designed for connection of ten conductors, in the housing 11 accordingly ten conductor inlet openings 12 and two actuating openings 16 for opening a respective spring force clamping terminal are also provided.

FIGS. 5 to 7 show that the individual contact legs 4, 5, with their second sections 4b, 5b, project from the bottom 17 of the housing 11, in particular with the regions of the second sections 4b, 5b on which the contact-making sections 4c, 5c are located. Thus, the contact-making sections 4c, 5c can make contact with the corresponding contact holes 3 in the circuit board 2 when the supply terminal 10 is being mounted on the circuit board 2.

In order to ensure good electrical contact between a connected electrical conductor and the terminal region 6 of a plug contact 1, on the side of the section 6a of the terminal region 6 facing the clamping leg 14, several grooves 18 are provided, as is apparent from FIG. 1. This increases the unit pressure between a plugged-in conductor forced by the end of the clamping leg 14 against the section 6a, and the section 6a.

To attach the housing 11 of the electrical supply terminal 10 on the circuit board 2, on the bottom 17 of the housing 11 there are several adjusting elements 19 and on the two front ends of the housing 11 there are several locating elements 20 each of which project from the bottom 17 of the housing 11 and can be plugged into corresponding recesses in the circuit board 2. To produce the latching in the corresponding recesses in the circuit board 2, each of the two locating elements 20 can have locating lugs which are opposite one another. Using a locking pin which is made to be movable in the longitudinal direction of the locating element 20 and which is located between the opposite locating lugs, the locating lugs can be prevented from unwantedly springing back when the locking pin is in its locking position between the two locating lugs.

In order to be able to easily open the clamping site between the free end of the clamping leg 14 of the clamping spring 13 and the opposite terminal region 6 of a plug contact 1, a respective actuating pusher 21 is movably located in the actuating openings 16. When the actuating pusher 21 is forced into the actuating opening 16 of the housing 11, the actuating pusher 21 deflects the clamping leg 14 of the clamping spring 13 against its spring force so that a connected conductor can be withdrawn from the clamping site or a flexible conductor can be inserted into the clamping site.

1-11. (canceled)

12. A plug contact for making electrical contact with a circuit board by plugging of the plug contact into a contact hole in the circuit board, comprising:
two contact legs which are resilient relative to one another, each of the legs having a first section and a second section which adjoins the first section in a plug-in direction of the plug contact,
a terminal region, and
a connecting region, the connecting region connecting the two contact legs to one another and to the terminal region,
wherein the two contact legs are bent out of a plane of the connecting region such that the connecting region and the first sections of the two contact legs which border the connecting region together form a U-shaped outline, and
wherein contact-making region of the contact legs are formed on oppositely facing outer sides of the second sections of the contact legs and are arranged for making contact with a perimeter wall of the contact hole in a plugged-in state of the plug contact.

13. The plug contact in claim 12, wherein the contact-making region has an outside contour which is rounded in cross section.

14. The plug contact in claim 13, wherein the contact-making region is crowned.

15. The plug contact in claim 12, wherein the two contact legs are located mirror-symmetrically relative to one another at a distance from one another over the entire length thereof, the distance being least in a region of free ends of the contact legs.

16. The plug contact in claim 12, wherein the contact-making region of each of the two contact legs has a smaller width than that of the first section.

17. The plug contact in claim 1, wherein each of the contact legs has a thickness of less than 0.5 mm.

18. An electrical supply terminal, comprising:
a housing,
a conductor terminal element,
a conductor bar piece,
a plug contact is located in the housing, and
an electrical conductor which is connectable in an electrically conductive manner to the conductor bar piece by the conductor terminal element,
wherein the housing has a conductor entry opening for entry of the electrical conductor to be connected,
wherein the conductor bar piece is formed by at least a section of a terminal region of the plug contact,
wherein the plug contact has two contact legs which are resilient relative to one another, each of the legs having a first section and a second section which adjoins the first section in a plug-in direction of the plug contact, and
wherein the second section projects from a bottom side of the housing.

19. The electrical supply terminal in claim 18, wherein the conductor terminal element is a clamping spring located in the housing, the clamping spring having a clamping leg and a contact leg, the clamping leg, acting together with the terminal region of the plug contact forming a spring force clamping terminal for an electrical conductor which is to be connected, and wherein an actuating opening is located in the housing for opening of the spring force clamping terminal.

20. The electrical supply terminal in claim 19, wherein a plurality of grooves or notches are formed on a side of the terminal region facing the clamping leg.

21. The electrical supply terminal in claim 18, wherein several adjusting elements for insertion into corresponding recesses in a circuit board are formed on the bottom of the housing.

22. The electrical supply terminal in claim 19, wherein, in the actuating opening, there is an actuating pusher that is movable out of a first position in which the spring force clamping terminal is closed into a second position in which an end facing the clamping leg deflects the clamping leg against the spring force of the clamping spring so that the spring force clamping terminal is opened.
